(19) United States
(12) Patent Application Publication
(10) Pub. No.: US 2009/0112719 A1
(43) Pub. Date: Apr. 30, 2009

(54) BRANDED INTER-PERSONAL COMMUNICATIONS

(76) Inventors: Mahesh P. Bhave, San Diego, CA (US); William Frantz, Palo Alto, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 12/239,511

(22) Filed: Sep. 26, 2008

Related U.S. Application Data
(60) Provisional application No. 60/975,253, filed on Sep. 26, 2007.

(51) Int. Cl. G06F 3/048; G06F 15/16; G06Q 30/00

(52) U.S. Cl. 705/14; 715/752; 705/35; 705/37

(57) ABSTRACT

A message is received from a content provider. A selection of one or more files is received from the content provider. A page specification is received from a first entity, the page specification indicating one or more assets to be displayed in a message interface. The page specification further specifies the placement of the one or more assets in the message interface. The page specification further specifies that at least one of the assets to be displayed in the message interface is to be selected by the content provider. A message interface is generated based on the page specification. The message and a set of links to the one or more files are displayed in the message interface.

### CROSS REFERENCE TO RELATED APPLICATIONS

This application claims priority under 35 U.S.C. § 119(e) from U.S. Provisional Patent Application No. 60/975,253, titled “Branded, Inter-Personal Communications” filed Sep. 26, 2007, which is incorporated by reference herein in its entirety.

### BACKGROUND

1. Field of the Invention

The invention relates generally to the transmission of files and information. Specifically, this invention relates to a platform that allows users to specify a graphical user interface for displaying messages containing links to files.

2. Description of Background Art

File sharing services such as those utilizing direct File Transfer Protocol provide users with the ability to transmit files over the internet. Although these services provide great utility, users of these services can only display files and other content transmitted using these services in the interface specified by the provider or host of the file sharing services.

Often, users of file sharing services such as end-users or administrators of the file sharing service wish to customize their personal communications using interface elements such as images, audio files, video files, brand logos or executable code. However, even if the user of the file sharing service had the ability to modify the graphical user interface specified by the provider of the file sharing service, interface generation is not a simple task. An advanced understanding of interface design and markup languages is required to author or modify a graphical user interface.

Further, an administrator of a file sharing service may wish to monetize the “real estate” or area of the graphical user interface by providing advertising content within the graphical user interface. To prevent unwanted content from being displayed, the administrator of the file sharing service may accordingly wish to select, organize, or filter the different interface elements and advertising content displayed in user interface.

Consequently, methods for customizing graphical user interfaces for displaying messages containing links to files are needed.

### SUMMARY OF THE INVENTION

Embodiments of the present invention enable the display of a message in a message interface generated, in part, based on the selection of an asset by a content provider.

One embodiment of the present invention comprises a computer system for displaying a message. The system comprises a message interface adapted to receive a message and a selection of one or more files from a content provider. The system further comprises a page specification engine adapted to receive a page specification from a first entity, the page specification indicating one or more assets to be displayed in a message interface and the placement of the one or more assets in the message interface wherein at least one of the assets to be displayed in the message interface is to be selected by the content provider. The system further comprises a message interface generation engine adapted to generate a message interface based on the page specification. The message interface is further adapted to display the message and a set of links to the one or more files in the message interface.

An embodiment of the present invention comprises is a computer-implemented method for displaying a message. A message is received from a content provider. A selection of one or more files is received from the content provider. A page specification is received from a first entity, the page specification indicating one or more assets to be displayed in a message interface. The page specification further specifies the placement of the one or more assets in the message interface. The page specification further specifies that at least one of the assets to be displayed in the message interface is to be selected by the content provider. A message interface is generated based on the page specification. The message and a set of links to the one or more files are displayed in the message interface.

Another embodiment of the present invention comprises a computer-readable storage medium encoded with computer program code for displaying a message according to the above described method.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a high-level block diagram of a system according to one embodiment of the present invention.

FIG. 2 is a graphical representation of a display illustrating a graphical user interface for displaying messages containing links to files (Prior Art).

FIG. 3 is a graphical representation of a display illustrating a customized graphical user interface for displaying messages containing links to files and assets according to one embodiment of the present invention.

FIG. 4 is a graphical representation of a display illustrating a customized graphical user interface for displaying messages containing links to files and assets according to another embodiment of the present invention.

FIG. 5 is a graphical representation of a display illustrating a customized graphical user interface for displaying messages containing links to files and assets according to yet another embodiment of the present invention.

FIG. 6 is a graphical representation of a display illustrating a customized graphical user interface for displaying messages containing links to files and assets according to still another embodiment of the present invention.

FIG. 7 is a high level block diagram showing the branded communications server according to one embodiment of the present invention.

FIGS. 8a and 8b are flow-charts illustrating steps performed by the branded communications server to store assets according to embodiments of the present invention.

FIG. 8c is a flowchart illustrating steps performed by the branded communications server to store a page specification according to one embodiment of the present invention.

FIG. 9 is a flowchart illustrating steps performed by the branded communications server to provide messages according to one embodiment of the present invention.

FIG. 10a is a flowchart illustrating steps performed by the branded communications server to generate a message interface according to one embodiment of the present invention.

FIG. 10b is a flowchart illustrating steps performed by the branded communications server to generate a message interface according to one embodiment of the present invention.

FIG. 11 is a flow-chart illustrating steps performed by the branded communications server to generate a message interface according to one embodiment.

The figures depict preferred embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

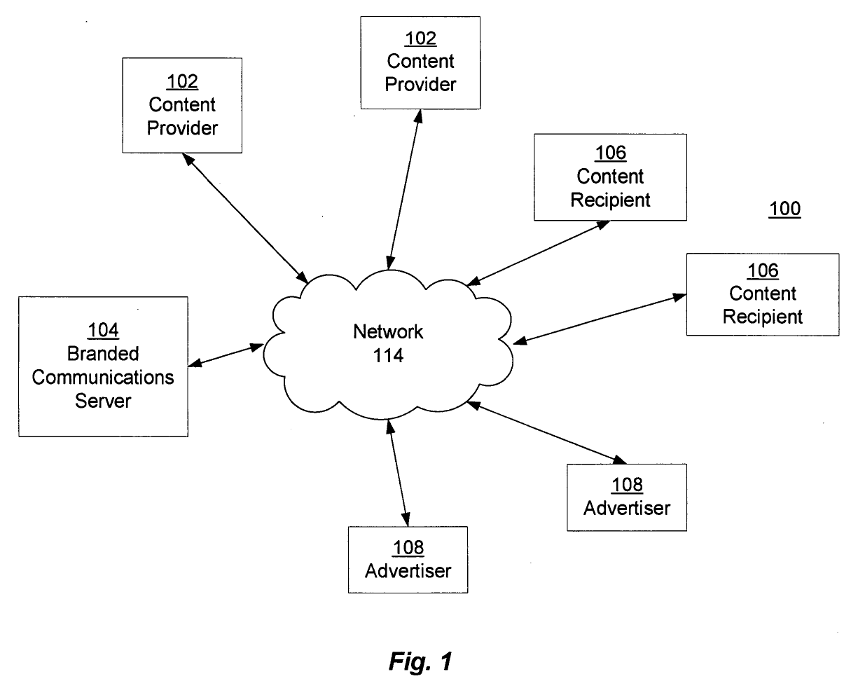

FIG. 1 illustrates an embodiment of a system 100 comprising a branded communications server 104, a plurality of content providers 102, a plurality of content recipients 106 and a plurality of advertisers 108 connected by a network 114. Only two content providers 102, two content recipients 106 and two advertisers 108 are shown in FIG. 1 in order to simplify and clarify the description. Other embodiments of the system 100 can have hundreds or thousands of content recipients 106, content providers 102 and/or advertisers 108 connected to the network 114.

The branded communications server 104, the content providers 102 content recipients 106 and the advertisers 108 are computing devices. The content providers 102, content recipients 106 and/or the advertisers 108 can be personal computers executing a web browser such as Microsoft Internet Explorer that allows the user to retrieve and display content from web servers and other computers on the network 114. In other embodiments, branded communications server 104, the content providers 102, content recipients 106 and/or the advertisers 108 are network-capable computing devices other than a personal computer, such as a personal digital assistant (PDA), a Smartphone, a mobile telephone, a pager, a television “set-top box,” etc. For purposes of this description, the term “computing device” also includes computers such as servers and gateways. For example, a computing device can be a network gateway located between an enterprise network and the Internet.

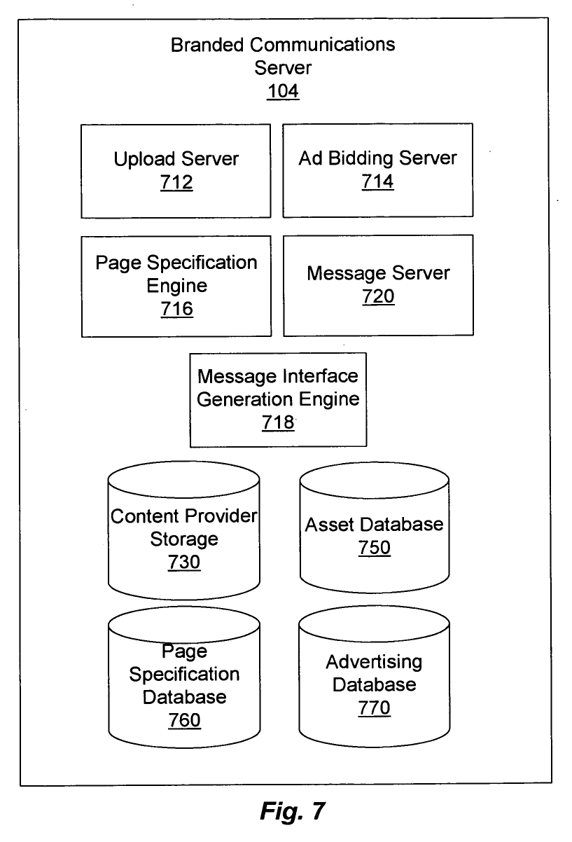

In most embodiments, the branded communications server 104 is comprised of one or more servers. In some embodiments, the branded communications server 104 is an edge server. In a specific embodiment, the branded communications server 104 is a portable server and the administrator of the branded communications server 104 may carry the branded communications server 104 on their person. The branded communications server 104 is described in more detail below with the reference to FIG. 7.

The network 114 represents the communication pathways between the branded communications server 104, the plurality of content providers 102, the plurality of content recipients 106 and the plurality of advertisers 108. In one embodiment, the network 114 is the Internet. The network 114 can also utilize dedicated or private communications links that are not necessarily part of the Internet. In one embodiment, the network 114 uses standard communications technologies and/or protocols. Thus, the network 114 can include links using technologies such as Ethernet, 802.11, integrated services digital network (ISDN), digital subscriber line (DSL), asynchronous transfer mode (ATM), etc. Similarly, the networking protocols used on the network 114 can include the transmission control protocol/internet protocol (TCP/IP), the hypertext transport protocol (HTTP), the simple mail transfer protocol (SMTP), the file transfer protocol (FTP), etc. The data exchanged over the network 114 can be represented using technologies and/or formats including the hypertext markup language (HTML), the extensible markup language (XML), etc. In addition, all or some of links can be encrypted using conventional encryption technologies such as the secure sockets layer (SSL), secure HTTP and/or virtual private networks (VPNs). In another embodiment, the entities can use custom and/or dedicated data communications technologies instead of, or in addition to, the ones described above.

The branded communications server 104 communicates with the content providers 102, the content recipients 106 and advertisers 108 over the network 114. The content providers 102, advertisers 108 and content recipients 106 are computing devices that may be operated by any type of entity ranging from an individual user, a company, an organization (e.g. university, non-profit organization) or another computing device. Accordingly, the content providers 102, advertisers 108 and content recipients 106 may comprise a single computing device or multiple computing devices.

Similarly, the branded communications server 104 may be administered by an individual, a company or an organization. The provider of the branded communications server 104 is an entity that creates and/or maintains the executable program code that provides the functionality of the branded communications server 104. In some instances, the provider of the branded communications server 104 is the administrator of the branded communications server 104. In some embodiments, the administrator of the branded communications server 104 subscribes to receive the executable program code that provides functionality of the branded communications server 104. In most embodiments, the administrator of the branded communications server 104 enters into a licensing agreement with the provider of the branded communications server 104 in order to receive the executable program code that provides the functionality of the branded communications server 104. In most embodiments, the license agreement includes terms for sharing revenue generated using the branded communications server 104 between the administrator and the provider of the branded communications server 104. In a specific embodiment, the licensing agreement terms require the administrator of the branded communications server 104 to provide a percentage or a defined amount of advertising funds received from displaying advertising content using the branded communications server 104 to the provider of the branded communications server 104.

The branded communications server 104 allows the content providers 102 to transmit messages including links to files to content recipients 106. The branded communications server 104 provides an interface which allows the content providers 102 to specify one or more links to files on the content provider's 102 system and/or the branded communications server 104 and provide a textual message to accompany the links to the files. The branded communications server 104 further provides an upload interface to allow the content provider 102 to upload files to the branded communications server 104. In some embodiments, the content provider 102 uploads files to the branded communications server 104 using direct File Transfer Protocol or direct Hypertext Transfer Protocol techniques.

The branded communications server 104 further allows the content providers 102 with the ability to customize the graphical user interface in which messages and links to the files are provided to the content recipients 106, herein referred to as the “message interface.” Similarly, the branded communications server 104 allows administrators of the branded communications server 104 and advertisers 108 to customize the message interface.

The branded communications server 104 allows content providers 102, advertisers 108 and administrators of the branded communications server 104 to customize message interfaces by specifying assets and page specifications. The branded communications server 104 generates the message interfaces based on the specified assets and page specifications. Assets are items of media content such as images (e.g. pictures, photographs, and brand logos), videos, links to web pages or audio files that are displayed in the message interface. Assets can also include embedded or executable code such as embedded video players. Page specifications define the placement of the assets in the message interface. The page specifications further define other entities that are allowed to specify assets to be displayed.

The branded communications server 104 receives and stores assets from the administrators, content providers 102 and the advertisers 108 via an upload server (not shown). The branded communications server 104 further receives and stores page specifications from the administrator of the branded communications server 104, the content providers 102 and advertisers 108. The branded communications server 104 provides a user interface for the content providers 102 and advertisers 108 to define the page specifications.

The branded communications server 104 further receives “bids,” “offers” or agreements to provide funds in exchange for the display of assets in message interfaces from the advertisers 108. The advertisers 108 may place bids for display of assets in a subset of the message interfaces based on information associated with the content provider 102, information associated with the content recipient 106 or information included in the message (e.g. type of file, keywords in message text, recipient, sender, etc.).

This branded communications server 104 is beneficial in that it customizes the message interface. The branded communications server 104 further allows multiple entities to display assets in the message interface, allowing multiple entities to contribute to the customization of the message interface. By providing an interface that allows the entities to specify page specifications, the branded communications server 104 allows the entities to customize the message interface without knowledge of markup languages such as HTML or other publication authoring tools.

Providing advertising content in the message interface further allows the administrator of the branded communications server 104 to generate revenue based on the display of assets in the message interfaces. This approach is equally beneficial to the advertisers 108 as it allows the advertisers 108 to display assets containing advertising content in messages interfaces directed to specific content recipients 106. The revenue generated based on the display of assets can help absorb costs associated with maintaining the branded communications server 104, thus allowing the content providers 102 and content recipients 106 to transmit messages containing links to files without providing funds to use the branded communications server 104.

Files, messages, page specifications and assets are uploaded to the branded communications server 104 via the Internet from a personal computer, through a cellular network from a telephone or PDA, or by other means for transferring data over the network 114. The administrator of the branded communications server 104 uploads information such as files, messages, page specifications and assets directly to branded communications server 104 from computer readable storage media or any other storage. The means by which messages and assets are displayed to the content recipient 106 in the message interface need not match the means by which it is uploaded. For example, a content provider 102 may upload a message and a page specification via a browser on a personal computer, whereas the content recipient 106 may view that video as a stream sent to a PDA. Note also that the branded communications server 104 may itself serve as the content provider 102.

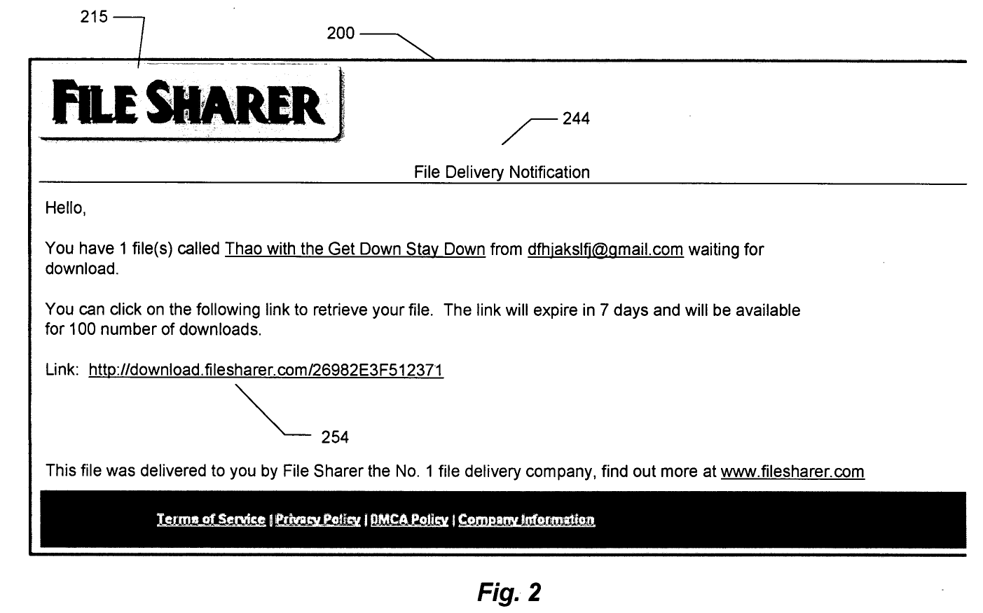

FIG. 2 (Prior Art) illustrates a graphical representation of a display of a graphical user interface 200 for displaying messages containing links to files on a sender's computer.

The graphical user interface 200 displays a message and images. The graphical user interface 200 contains the logo 215 of the file delivery service, a link 254 to a file and a notification 244 of a file delivery.

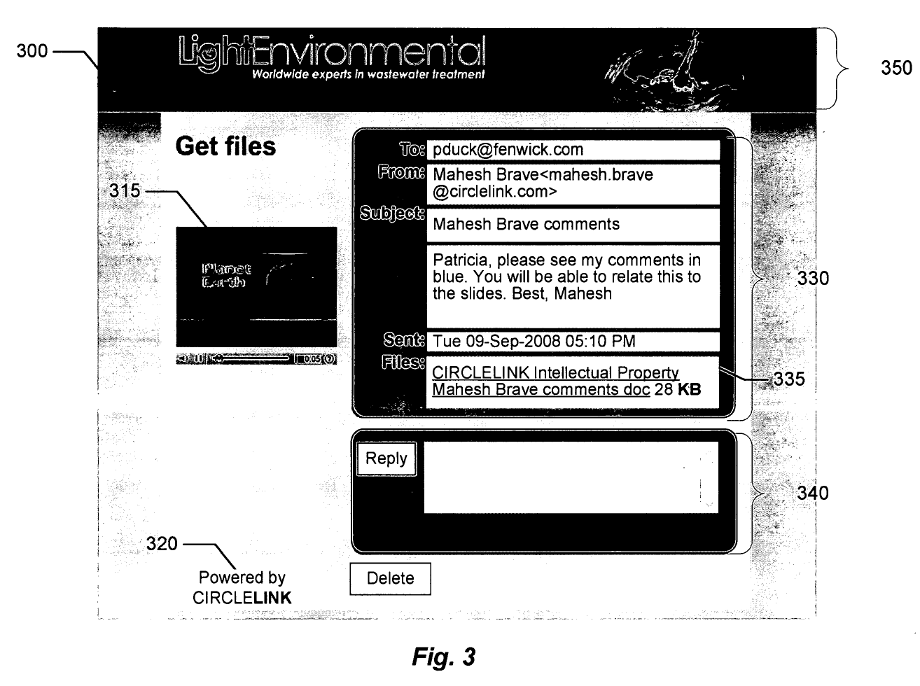

FIG. 3 illustrates a graphical representation of a display of a message interface 300 for displaying messages containing links to files and assets according to one embodiment. In the embodiment illustrated, the branded communications server 104 generates a message interface 300 according to a page specification provided by the content provider 102. In the illustrated screenshot, the page specification is provided by a content provider 102 that is a company. In other instances, the content provider 102 may be an individual, a group or an organization.

The message interface 300 includes a display window 330 for displaying a message from the content provider 102 including links to files provided by the content provider 102. The display window 330 includes a file window 335 including links to files available for downloading. The message interface 300 further includes a reply window 340 that the content recipient 106 may use to enter a text message in response to the message from the content provider 102. The customized message interface 300 further displays a set of fixed assets according to the page specification specified by the content provider 102. The customized message interface 300 displays fixed assets provided by the content provider 102 including: a banner 350 with the content provider's 104 logo, a video 315 summarizing the content provider's 104 company and a logo 320 indicating the administrator/provider of the branded communications server 104.

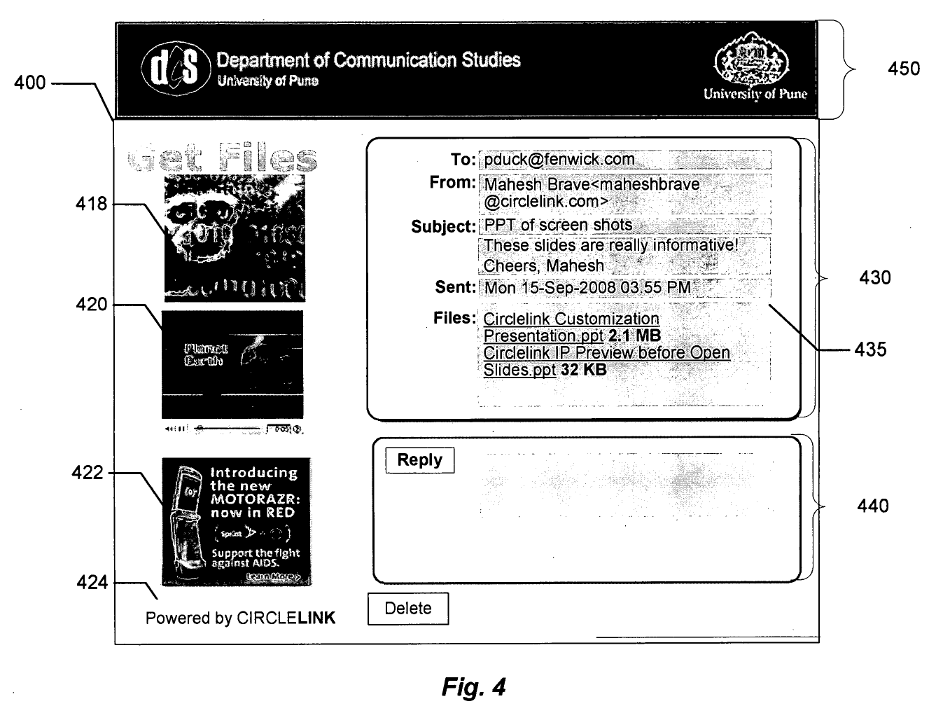

FIG. 4 illustrates a graphical representation of a display of another embodiment for a message interface 400 for displaying messages having links to files and assets. In the embodiment illustrated, the branded communications server 104 generates the message interface 400 according to a page specification provided by an administrator of the branded communications server 104. In the illustrated embodiment, the page specification is provided by an administrator of a branded communications server 104 that is affiliated with an academic institution. In other instances, the administrator of the branded communications server 104 may be an individual, a company (e.g. a telecommunications company or an internet services provider) or an organization (e.g. a non-profit organization).

The message interface 400 includes a display window 430 for displaying a message from the content provider 102 having links to files provided by the content provider's 102 In the illustrated embodiments, the content provider 102 is a student at the academic institution. The message interface 400 displays a file window 435 including links to files available for downloading. The message interface 400 further includes a reply window 440 that the content recipient 106 may use to enter a text message in response to the original message from the content provider 102. The message interface 400 further displays fixed assets according to a page specification specified by the administrator of the branded communications server 104. The page specification further specifies variable assets that include content selected by the advertisers 108 and content providers 102 and where the assets are placed in the message interface 400.

The message interface 400 displays fixed assets provided by the administrator of the branded communications server 103 such as a banner 450 for the academic institution's logo. The message interface 400 displays variable assets provided by the content provider 102 to customize the display including an image asset 418. The customized message interface 400 further displays variable assets including advertising content provided by advertisers 108 such as a video asset 420 provided by the advertiser 108 and an interactive ad 422 provided by the advertiser 108. The customized message interface 400 further displays variable assets such as the logo 424 of the provider of the branded communications server 104.

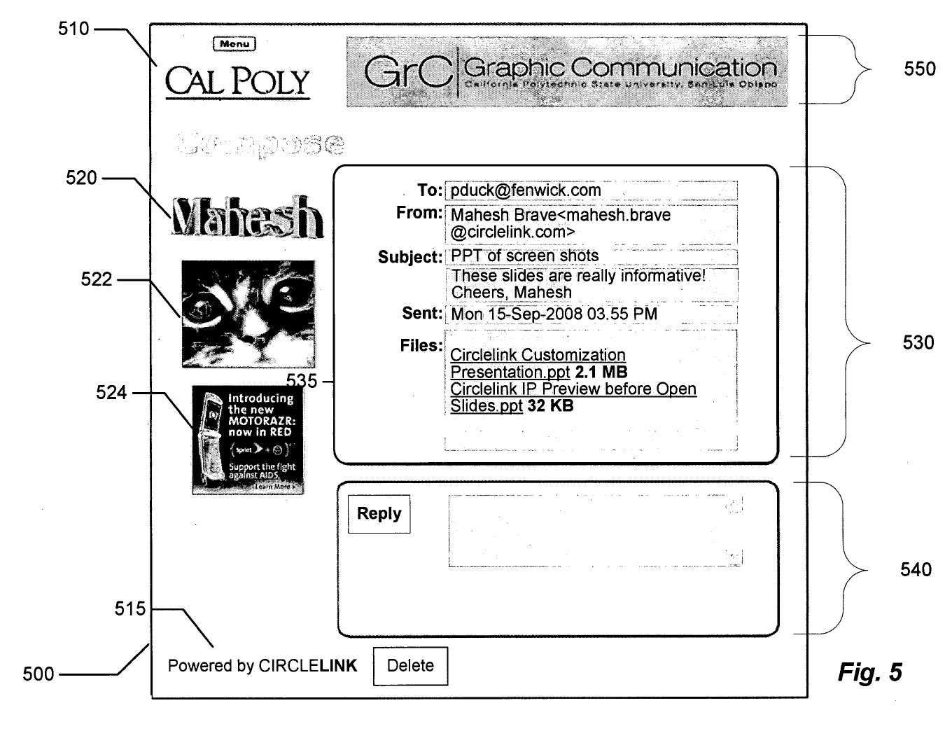

FIG. 5 illustrates yet another embodiment of a graphical representation of a display of a customized message interface 500 for displaying messages having links to files and assets. In the embodiment illustrated, the branded communications server 104 generates the customized message interface 500 according to a page specification provided by an administrator, such as an academic institution, of the branded communications server 104. In other instances, the administrator of the branded communications server 104 may be an individual, a company or an organization.

The message interface 500 includes a display window 530 for displaying a message from the content provider 102 with links to files on the content provider's 102 system. In the illustrated embodiments, the content provider 102 is a student at the academic institution. The message interface 500 displays a file window 535 including links to files available for downloading. The message interface 500 further includes a reply window 540 that the content recipient 106 may use to enter a text message in response to the message from the content provider 102. The message interface 500 further displays fixed assets according to a page specification specified by the administrator of the branded communications server 104. The page specification further specifies variable assets that display content provided by the advertisers 108 and content providers 102 and where the assets are placed in the customized message interface 500.

The customized message interface 500 displays fixed assets provided by the administrator of the branded communications server 104 including an image of the academic institution's logo 510 and a banner 550 including a logo of a department within the academic institution. The message interface 500 further displays variable assets provided by the content provider 102 to customize the display including an image 522 and a logo 520 of the content providers' 102 name. The message interface 500 further displays variable assets containing advertising content provided by advertisers 108 such as an interactive ad 524 provided by an advertiser 108. The message interface 500 further displays an asset containing the logo 515 of the provider of the branded communications server 104.

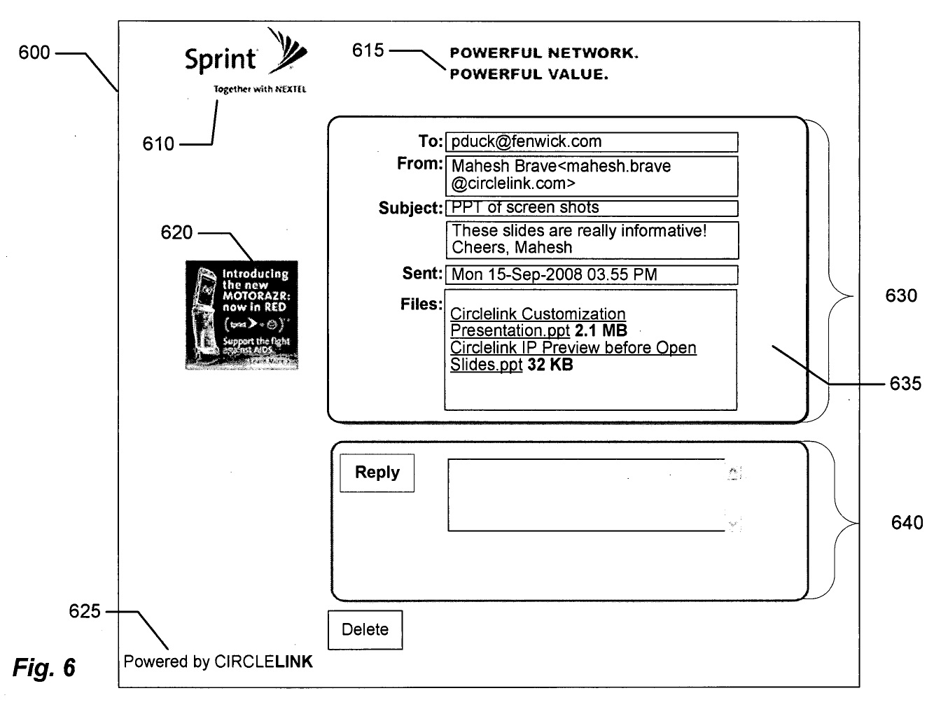

FIG. 6 illustrates a graphical representation of a display of a message interface 600 for displaying messages with links to files and assets In the embodiment illustrated, the branded communications server 104 generates customized message interface 600 according to a page specification provided by an advertiser 108. In the illustrated embodiment, the page specification is provided by an advertiser 108 that is a telecommunications company. In other instances, the advertiser 108 may be an individual, a group or an organization.

The message interface 600 includes a display window 630 for displaying a message from the content provider 102 having links to files on the content provider's 102 system. The message interface 600 displays a file window 635 including links to files available for downloading. The message interface 600 further includes a reply window 640 that the content recipient 106 uses to enter a text message in response to the message from the content provider 102. The customized message interface 600 further displays fixed assets according to a page specification specified by the advertiser 108. The customized message interface 600 displays fixed assets specified by the advertiser 108 including an image of the advertiser's 108 logo 610, an image of the advertisers' 108 motto 615, an interactive advertisement 620 for one of the advertiser's 108 products. The customized message interface 600 further displays a variable asset 625 including the logo of the content provider 102 of the branded communications server 104.

FIG. 7 is a high-level block diagram illustrating a detailed view of the branded communications server 104 according to one embodiment. As shown in FIG. 7 the branded communications server 104 includes several engines and servers. The branded communications server 104 comprises an upload server 712, an ad bidding server 714, a page specification engine 716, a message server 720, a message interface generation engine 718, a content provider storage 730, an asset database 750, a page specification database 760 and an advertising database 770. Those of skill in the art will recognize that other embodiments can have different engines and/or servers than the ones described here, and that the functionalities can be distributed among the engines and/or servers in a different manner. In addition, the functions ascribed to the branded communications server 104 can be performed by multiple servers.

The upload server 712 receives files uploaded by the content providers 102 and the advertisers 108. The upload server 712 allows the content providers 102 to specify a set of files to upload and store on the branded communications server 104. The content providers 102 specify the set of files to upload by specifying one or more directories from which to upload files or by manually selecting the files. The upload server 712 stores the uploaded files in the content provider storage 730. In a specific embodiment, the administrator of the branded communications server 104 allocates a defined amount of storage space in the content provider storage 730 for each content provider 102 to store files. In this embodiment, the administrator of the branded communications server 104 may require the content provider 102 to purchase additional storage space in the content provider storage 730 if the content provider's 102 storage usage exceeds their allotted amount of storage space.

The upload server 712 receives assets uploaded by the content providers 102 and the advertisers 108. The upload server 712 allows the content providers 102 and advertisers 108 upload the assets as described above with reference to files. The upload server 712 further stores these assets uploaded by the content providers 102 and the advertisers 108 in the asset database 750.

According to the embodiment, the upload server 712 may upload files and assets to the branded communications server 104 using different methods of file transfer. In one embodiment, the upload server 712 uploads files and assets to the branded communications server 104 using hypertext transfer protocol (HTTP). In another embodiment, the upload server 712 uploads files and assets to the branded communications server 104 using file transfer protocol (FTP).

In some embodiments, the content provider 102 or administrator of the branded communications server 104 may provide an access control list (ACL) associated with one or more files in the content provider storage 730. In these embodiments, the ACL specifies a list of emails of content providers 102 or content recipients 106 that are permitted to access the one or more files. The branded communications server 104 verifies permissions whenever a content recipient 106 or content provider 102 attempts to access the files. In some embodiments, the branded communications server 104 further requires content recipients 106 to provide a password to access the files in the content provider storage 730.

The asset database 750 stores the received assets in association with unique identifiers for the assets. As discussed above, the asset may have any type of digital content such as textual content, image content, video content, music content or executable/embedded code. In some embodiments, the assets are also be associated with display formatting information such as a set of dimensions specifying a size or resolution at which to display the asset in the message interface. Some assets in the asset database 750 are associated with a flag indicating that the asset includes content that is only to be displayed in message interfaces received by a subset of content recipients 106 (e.g. an asset containing advertising content for alcohol that is only to be displayed to content recipients 106 who are above the legal drinking age). Some assets in the asset database 750 are associated with flags specifying that the assets are to be displayed at one or more specific time intervals (e.g. that the assets are to be displayed in message interface for a specified duration of time, that the assets are to be displayed in message interface before an expiration date, that the assets are to be displayed in message interface on a specific day or at a specific time of day). These flags may be specified by an administrator of the branded communications server 104 or the content provider 102 or advertiser 108 that uploads the assets.

The ad bidding server 714 receives bids specifying agreements from advertisers 108 to provide funds in exchange for the display of assets containing advertising content in message interfaces provided to content recipients 106. In most embodiments, the ad bidding server 714 specifies the amount of funds to be provided in exchange for the display of the assets. The amount of funds to be provided may vary based on criteria such as the size of the assets or the advertiser 108, the time interval(s) at which the assets are to be displayed, placement of the assets in the message interface, a type of digital media associated with the asset (e.g., scrolling content, static content, video content, linked content). In some instances, the advertisers 108 may bid to provide page specifications describing one or more assets and style elements such as colors and fonts providing a “look and feel” of the message interface provided to content recipients 106. In most embodiments, the ad bidding server 714 allows the advertiser to specify an amount of funds the advertiser is willing to provide in exchange for displaying ad content as an asset or according to a page specification.

The ad bidding server 714 may further allow the advertiser 108 to specify that ad content is only to be displayed with a subset of the message interfaces based on information associated with the content provider 102, the content recipient 106, the files to be provided or the message. This information may include: a group associated with the content provider 102 and/or the content recipient 106, keywords or textual information included in the message to be displayed in the message interface and demographic or personal information associated with the content provider 102 and/or content recipient 106. For instance, the advertiser 108 may specify that their ad content is only to be displayed in message interfaces containing messages from content providers 102 belonging to a specific group of content providers 102 (e.g. architecture students). Likewise the advertiser 108 may specify that their ad content is only to be displayed in message interfaces displayed to content recipients 106 who belong to one or more demographics of content recipients 106 (e.g. females who are 18 or older).

The advertiser database 770 stores information provided by the advertisers 108. The advertiser database 770 stores a unique identifier for advertising content to be displayed in a message interface in association with information indicating the amount of funds the advertiser 108 agrees to provide in exchange for displaying the advertising content. The advertiser database 770 further stores information selected by the advertiser 108 to control the display of the ad content to a specific subset of message interfaces.

The advertiser database 770 further stores information derived from providing the ad content to content recipients 106 such as click-through-rates associated with the ad content and the frequency at which the ad content is viewed by the content recipients 106 (e.g. the rate at which an asset containing video content is viewed by the content recipients 106). The administrator of the branded communications server 104 uses the information derived from providing the ad content to the content recipients 106 to determine an amount of funds to receive from the advertisers 108. For instance, if an advertiser 108 bids to provide $10 in exchange for every thousand displays of an asset, in other works the advertiser agrees to provide a $10 cost per mile (CPM), containing advertising content, the administrator of the branded communications server 104 may determine the amount of funds to receive from the advertiser based on the number of views. Also, if an advertiser 108 bids to provide an additional $10 for every one thousand “click throughs” of an asset containing advertising content, the administrator of the branded communications server 104 may further determine the amount of funds to receive from the advertiser based on the click through rate associated with the asset.

In some embodiments, an interface (not shown) is provided to the advertiser 108 for viewing information derived from displaying the advertising content. The information derived from displaying the advertising content may be updated in the interface on a periodic basis or continuously updated in “real-time” as the advertising content is displayed. In some embodiments, the information derived from displaying the advertising content is provided to the advertiser 108 through an email or messaging service.

The page specification engine 716 provides an interface (not shown) for content providers 102, advertisers 108 and/or an administrator of the branded communications server 104 to specify a page specification that defines the message interface. The page specification engine 716 allows the content providers 102, advertisers 108 and/or an administrator of the branded communications server 104 to specify a page specification by specifying the placement of fixed and variable assets in the message interface. A fixed asset is an asset is that is always displayed in the message interface. The fixed assets are usually provided by the entity that specifies the page specification. A variable asset is an asset that is associated with an entity other than the entity who specifies the page specification. The variable assets may be selected by the other entities or automatically selected from assets provided by the other entities. The page specification engine 716 further allows the content providers 102, advertisers 108 and/or an administrator of the branded communications server 104 to specify a page specification by defining the “look and feel” of the message interface by specifying style elements such as fonts, background colors and display window colors.

In embodiments where multiple entities select assets to display in the message interface, only one of the entities (i.e. one of the content providers 102, the advertisers 108 or the administrator of the branded content server 104) provides the page specification. As above, the page specification engine 716 allows the entity who specifies the page specification to select a number of fixed assets associated with the entity (e.g. the entity's logo, a promotional video for the entity) that are to be displayed in the message interface and the look and feel of the message interface (e.g. color or message display window, the color of the message interface background).

The page specification engine 716 further allows the entity that specifies the page specifications to specify a set of variable assets to be displayed in the message interface, the entities that are permitted to select the variable assets and the placement of the variable assets in the message interface. Once the page specification has been specified by the entity, the page specification engine 716 further allows entities who are permitted to select the variable assets to select the variable assets to be displayed in the message interface.

In one embodiment, the administrator of the branded communications server 104 may define a page specification including one or more fixed assets. The page specification may further specify that one or more advertisers 108 and/or the content providers 102 are permitted to display a defined number of variable assets and the placement the variable assets. The page specification engine 716 then provides a user interface to the content provider 102 and/or advertiser 108 which allows the content provider 102 and/or advertiser 108 to select a variable asset to be displayed in the message interface. In some embodiments, the page specification engine 716 communicates with the message server 720 to allow a content provider 102 to select a variable asset to be displayed in a message interface in a same interface the content provider 102 uses to specify the message and the files to be sent to a content recipient 106.

In other embodiments, the advertiser 108 defines a page specification including one or more fixed assets. The page specification may further specify that the content providers 102 are permitted to display a defined number of variable assets and the placement of the variable assets. The page specification engine 716 then provides a user interface to the content provider 102 which allows the content provider 102 to select a variable asset to be displayed in the message interface. In some embodiments, the page specification engine 716 communicates with the message server 720 to allow a content provider 102 to select an variable asset to be displayed in a message interface in a same interface the content provider 102 uses to specify the message and the files to be sent to a content recipient 106.

In other embodiments, the content providers 102 may define a page specification including one or more fixed assets. The page specification may further specify that one or more advertisers 108 and/or the administrator of the branded content server 108 are permitted to display a defined number of variable assets and the placement of the variable assets. The page specification engine 716 then provides a user interface to the administrator of the branded communications server 104 and/or the advertiser 108 to select one or more assets to be displayed in the message interface.

In other embodiments, the entity that defines the page specification may also specify that the variable assets are to be selected automatically. In one embodiment, the advertising content that is displayed as one or more assets in the message interface is selected automatically. In some embodiments, the page specification engine 716 provides the entity who specifies the page specification with the ability to specify a set of advertisers 108 and select ad content by the advertisers 108 from the advertising database 770 on a rotating basis or based on other criteria such as the ad bids associated with the assets. In some embodiments, the page specification engine 716 provides the entity who specifies the page specification with the ability to select different assets provided by the same advertiser 108 on a rotating basis or based on other criteria.

The message server 720 allows content providers 102 to send messages containing links to files to content recipients 106. In most embodiments, the message server 720 requires the content provider 102 to register as a user of the branded communications server 104 in order to send messages. Upon registration, the message server 720 may request for the content provider 102 to submit personal information such as demographic information or groups the content provider 102 belongs to. In some embodiments, the message server 720 further requires the content recipients 106 to register with the branded communications server 104 in order to access the message.

The message server 720 provides an interface to the content provider 102 including a message window in which the content provider 102 inputs a textual message, a recipient window in which the content provider 102 may specify the content recipient 106 who is to receive the message and a file window in which the content provider 102 may specify the files to be transmitted with the message. In some embodiments, the message server 720 communicates with the upload server 712 to upload the specified files to the content provider storage 730. In some embodiments, the message server 720 communicates with the page specification engine 716 to allow the content provider 102 to select one or more assets to be displayed in the message interface.

In some embodiments, the interface provided by the message server 720 allows the content providers 106 to specify an access control list associated with the files specified in the message. As discussed above, the branded communications server 104 uses the access control list to verify which content recipients 106 are permitted to access the specified files. Using this interface, content provider 102 may further specify whether the content recipients 106 have permissions to forward the message to other content recipients 106 and/or the number of times the content recipients 106 can forward the message. According to the embodiment, the content provider 102 may specify that the content recipient 106 is required to provide a fee in order to forward the message. In a specific embodiment, the content provider 102 may specify that content recipients 106 selected by the content provider 102 may access the message without permission verification. The content provider 102 may further specify that content recipients 106 who receive forwarded messages must provide a password in order to verify permission to access the files.

The message server 720 identifies the page specification to be used to generate the message interface based on personal information associated with the content recipient 106, personal information associated with the content provider 102 and/or settings provided by the administrator of the branded communications server 104. The message server 720 communicates with the message interface generation engine 718 to generate the message interface in which to display the message based on the identified page specification. The message server 720 provides the message and links to the selected files to the content recipient 106 in the generated message interface.

In some embodiments, the branded communications server 104 is separate service from the content provider's 102 and/or content recipient's 106 primary electronic mail or messaging service. In these embodiments, the message server 720 sends a notification message to the content recipient's 106 primary electronic mail service or messaging service when a message is sent from the content provider 102 to the content recipient 106. If the content recipient's 106 primary message service is a mobile phone messaging service, the message server 720 transmits a text message to the content recipient 106. The notification message contains a hyperlink which re-directs the content recipient to an interface associated with the branded communications server 104 such as a website. In a specific embodiment, the message server 720 generates a message containing a hyperlink to a website associated with the branded communications server 104 containing a short uniform resource locator (URL) with a pseudo-random code embedded in the hyperlink.

When the content recipient 106 accesses the message at the branded communications server 104, the message server 720 transmits a delivery notification message to the content provider 102 specifying that the message and/or files have been accessed by the content recipient 106. The message server 720 provides an interface for the content provider 102 to view these notifications and other activity regarding the transmitted files.

The message server 720 displays the message and links to the files in the generated message interface. The message server 720 further displays a reply window in the generated message interface. The reply window provides a mechanism for the content recipient 106 to provide a textual message to the content provider 102 responsive to the received message. The message server 720 transmits messages provided in the reply window by the content recipient 106 to the content provider 102 using content providers 102 primary messaging service.

The message server 720 further functions to generate information associated with displaying the assets in the displayed message interface. The message server 720 monitors click through rates associated with assets containing links to advertising content. The message server further monitors user interaction with assets such as video players. The message server 720 stores the information associated with displaying the assets in the advertising database 770.

The message interface generation engine 718 communicates with the message server 720 to receive a request to send a message from a content provider 102 to a content recipient 106. The message interface generation engine 718 identifies the page specification that defines the message interface based on the settings provided by the administrator of the branded communications server 104. The message interface generation engine 718 generates a message interface including the message and the links to specified files according to the page specification.

The message interface generation engine 718 generates the message interface based on a page specification, the message provided by the content provider 102 and one or more files specified by the content provider 102. In some embodiments, the message interface generation engine 718 generates the message interface based on a page specification including fixed assets defined by one entity and variable assets selected by other entities. The message interface generation engine 718 retrieves the selected assets and the assets specified in the page specification from the asset database 750.

In some embodiments, the message interface generation engine 718 generates images or icons containing “previews” of the files and provides the images in association with the links to the files in the message interface. In these embodiments, the message interface generation engine 718 identifies files containing digital images such as video or image files and selects a representative image from the file to display in association with a link to the file.

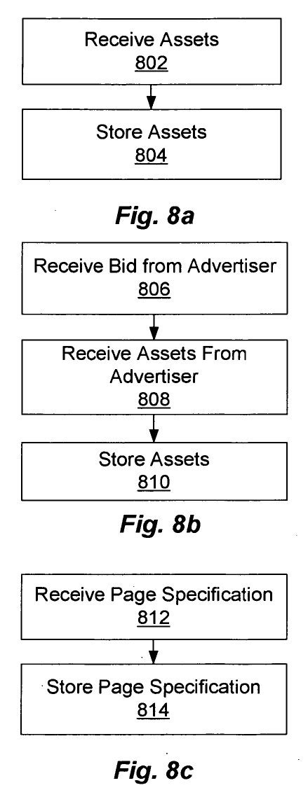

FIG. 8a is a flowchart illustrating steps performed by the branded communications server 104 to receive and store assets. Other embodiments perform the illustrated steps in different orders, and/or perform different or additional steps. Moreover, some of the steps can be performed by engines or modules other than the branded communications server 104.

The branded communications server 104 receives 802 assets specified by a content provider 102 and/or an administrator of the branded communications server 104. The branded communications server 104 stores 804 the assets in the asset database 750.

FIG. 8b is a flowchart illustrating steps performed by the branded communications server 104 to receive and store assets from advertisers 108. Other embodiments perform the illustrated steps in different orders, and/or perform different or additional steps. Moreover, some of the steps can be performed by engines or modules other than the branded communications server 104.

The branded communications server 104 receives 806 a bid to display assets containing advertising content from an advertiser 108. The branded communications server 104 receives 808 assets specified by an advertiser 108. The branded communications server 104 stores 810 the assets in the asset database 750.

FIG. 8c is a flowchart illustrating steps performed by the branded communications server 104 to receive and store page specifications. Other embodiments perform the illustrated steps in different orders, and/or perform different or additional steps. Moreover, some of the steps can be performed by engines or modules other than the branded communications server 104.

The branded communications server 104 receives 812 a page specification from an advertiser 108, an administrator of the branded communications server 104 or a content provider 102. The branded communications server 104 stores 814 the page specification in the page specification database 760.

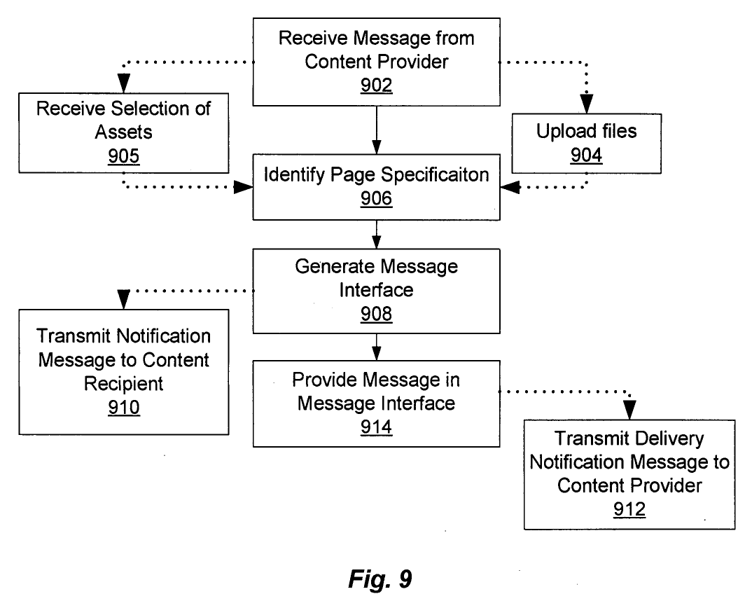

FIG. 9 is a flowchart illustrating steps performed by the branded communications server 104 to generate a message interface according to one embodiment. Other embodiments perform the illustrated steps in different orders, and/or perform different or additional steps. Moreover, some of the steps can be performed by engines or modules other than the branded communications server 104.

The branded communications server 104 receives 902 message content from the content provider 102. In some embodiments, the branded communications server 104 receives a selection of files and uploads 904 or otherwise identifies the selected file(s) to the branded communications server 104. In some embodiments, the branded communications server 104 receives 905 a selection of one or more assets from the content provider 102. The branded communications server 104 identifies 906 a page specification. The branded communications server 104 generates 908 the message interface based on the page specification, the message, the selected assets and the selected files. In some embodiment, the branded communication server 104 transmits a notification of the message to the content recipient 106, the notification message containing a link to the message on the branded communications server 104. The branded communications server 104 provides the message and links to the files to the content recipient 106 in the message interface responsive to the content recipient 106 accessing the message through the branded communications server 104. In some embodiments, the branded communications server 104 transmits a delivery notification message to the content provider 102 responsive to the content recipient 106 accessing the message through the branded communications server 104.

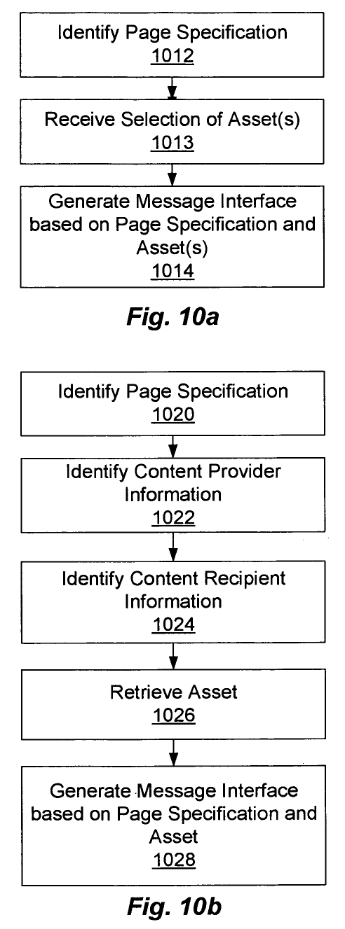

FIG. 10a is a flowchart illustrating steps performed by the branded communications server 104 to generate a message interface according to one embodiment. Other embodiments perform the illustrated steps in different orders, and/or perform different or additional steps. Moreover, some of the steps can be performed by engines or modules other than the branded communications server 104.

The branded communications server 104 identifies 1012 a page specification specified by an entity such as an advertiser 108, an administrator of the branded communications server or a content provider 102 based on personal information associated with the content recipient 106, personal information associated with the content provider 102 and/or settings provided by the administrator of the branded communications server 104, the page specification indicating one or more assets which may be specified by at least one other entity. The branded communications server 104 receives 1013 a selection of the one or more variable assets by at least one other entity. The branded communications server 104 generates 1014 a message interface based on the selected variable asset(s) and the identified page specification.

FIG. 10b is a flowchart illustrating steps performed by the branded communications server 104 to generate a message interface according to one embodiment. Other embodiments perform the illustrated steps in different orders, and/or perform different or additional steps. Moreover, some of the steps can be performed by engines or modules other than the branded communications server 104.

The branded communications server 104 identifies 1020 a page specification specified by an entity based on personal information associated with the content recipient 106, personal information associated with the content provider 102 and/or settings provided by the administrator of the branded communications server 104. The branded communications server 104 identifies 1022 information associated the content provider 102. The branded communications server 104 identifies 1024 information associated with the content recipient 106. The branded communications server 104 retrieves 1026 a variable asset having advertising content from the asset database 750 based on the identified information associated with content recipient 106 and/or content provider 102. The branded communications server 104 generates 1028 a message interface based on the page specification and the retrieved variable asset.

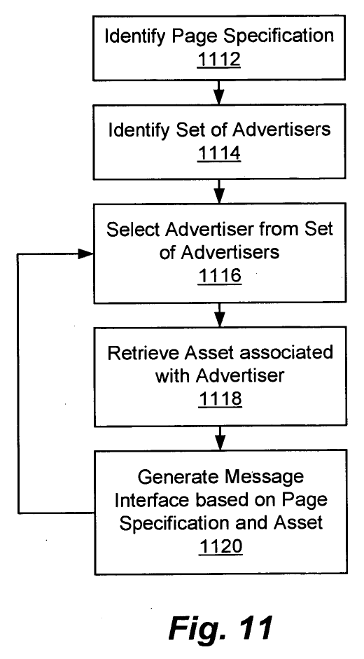

FIG. 11 is a flowchart illustrating steps performed by the branded communications server 104 to generate a message interface according to one embodiment. Other embodiments perform the illustrated steps in different orders, and/or perform different or additional steps. Moreover, some of the steps can be performed by engines or modules other than the branded communications server 104.

The branded communications server 104 identifies a page specification specified by an entity. The branded communications server 104 identifies a set of advertisers 108. The branded communications server 104 selects an advertiser from the set of advertisers 108 on a rotating basis and/or based on criteria specified by the entity such the ad bid associated with the advertiser 108. The branded communications server 104 retrieves a variable asset containing advertising content from the asset database 750 associated with the advertiser 108. The branded communications server 104 generates a message interface based on the page specification and the retrieved variable asset. The branded communications server selects a next advertiser 108 from the set of advertisers 108 on the rotating basis and/or based on the criteria specified by the entity and generates a new message interface including a new variable asset associated with the next advertiser 108.

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. For example, the particular functions of the branded communications server 104 may be provided in many or one module.

Some portions of the above description present the feature of the present invention in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. All such process steps, instructions or algorithms are executed by computing devices that include some form of processing unit (e.g., a microprocessor, microcontroller, dedicated logic circuit or the like) as well as a memory (RAM, ROM, or the like), and input/output devices as appropriate for receiving or providing data.

The present invention also relates to an apparatus for performing the operations herein. This apparatus may be specially constructed for the required purposes, or it may comprise a general-purpose computer selectively activated or reconfigured by a computer program stored in the computer, in which event the general-purpose computer is structurally and functionally equivalent to a specific computer dedicated to performing the functions and operations described herein. A computer program that embodies computer executable data (e.g. program code and data) is stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for persistently storing electronically coded instructions. It should be further noted that such computer programs by nature of their existence as data stored in a physical medium by alterations of such medium, such as alterations or variations in the physical structure and/or properties (e.g., electrical, optical, mechanical, magnetic, chemical properties) of the medium, are not abstract ideas or concepts or representations per se, but instead are physical artifacts produced by physical processes that transform a physical medium from one state to another state (e.g., a change in the electrical charge, or a change in magnetic polarity) in order to persistently store the computer program in the medium. Furthermore, the computers referred to in the specification may include a single processor or may be architectures employing multiple processor designs for increased computing capability.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

1. A method of displaying a message, the method comprising:
receiving a message from a content provider;
receiving a selection of one or more files from the content provider;
receiving a page specification from a first entity, the page specification indicating one or more assets to be displayed in a message interface and the placement of the one or more assets in the message interface wherein at least one of the assets to be displayed in the message interface is to be selected by the content provider;
generating a message interface based on the page specification; and
displaying the message and a set of links to the one or more files in the message interface.

2. The method claim 1, wherein the page specification is received from a first entity and further comprising:
receiving a selection of the at least one asset from the content provider; and
generating the message interface including the selected at least one asset.

3. The method claim 1, wherein at least one of the assets to be displayed in the message interface is to be selected by an advertiser and further comprising:
receiving a selection of the at least one asset from the advertiser;
generating the message interface including the selected at least one asset.

4. The method claim 1, further comprising:
receiving an agreement to provide funds in exchange for the display of an asset from an advertiser;
receiving an asset to be displayed from the advertiser; and
displaying the asset in the message interface.

5. The method claim 3, further comprising:
monitoring an interaction with the asset in the message interface; and
receiving funds from the advertiser, based in part on the interaction.

6. The method claim 3, further comprising:
receiving a plurality of bids from a plurality of advertisers;
receiving a plurality of assets from the plurality of advertisers;
selecting an asset from the plurality of assets from the plurality of advertisers based on a rotating list of advertisers;
displaying the selected asset in the message in the message interface.

7. The method of claim 3, wherein receiving an agreement to provide funds in exchange for the display of an asset from an advertiser comprises:
receiving an agreement to provide funds in exchange for the display of an asset in message interfaces associated with messages provided by a set of content provider, where the set of content providers as associated with a group of content providers.

8. The method of claim 3, wherein receiving an agreement to provide funds in exchange for the display of an asset from an advertiser comprises:
receiving an agreement to provide funds in exchange for the display of an asset in message interfaces associated with a set of content recipients, wherein the set of content recipients are associated with a group of content recipients.

9. The method of claim 1, further comprising:
receiving the page specification from the content provider;
receiving an asset from an advertiser; and
generating the message interface based on the page specification and the asset.

10. The method of claim 1, further comprising:
receiving the page specification from an advertiser;
receiving an asset from a content provider; and
generating the message interface based on the page specification and the asset.

11. The method of claim 1, further comprising:
receiving the page specification from an administrator;
receiving a first asset from an advertiser; and
generating the message interface including the first asset based on the page specification

12. The method of claim 1, further comprising:
receiving a second asset from a content provider; and
generating the message interface including the second asset.

13. The method of claim 1, wherein displaying the message and a set of links to the one or more files in the message interface comprises:
transmitting a notification email comprising a link to the message interface to a content recipient; and
displaying the message and a set of links to the one or more files in the message interface, responsive to the content recipient accessing the link to the message interface.

14. A computer readable storage medium encoded with computer program code for displaying a message, the program code comprising program code for:
receiving a message from a content provider;
receiving a selection of one or more files from the content provider;
receiving a page specification from a first entity, the page specification indicating one or more assets to be displayed in a message interface and the placement of the one or more assets in the message interface wherein at least one of the assets to be displayed in the message interface is to be selected by the content provider;
generating a message interface based on the page specification; and
displaying the message and a set of links to the one or more files in the message interface.

15. The medium of claim 14, wherein the page specification is received from a first entity and the program code further comprises program code for:
receiving a selection of the at least one asset from the content provider; and
generating the message interface including the selected at least one asset.

16. The medium of claim 14, wherein at least one of the assets to be displayed in the message interface is to be selected by an advertiser and the program code further comprises program code for:
receiving a selection of the at least one asset from the advertiser;
generating the message interface including the selected at least one asset.

17. A computer system for displaying a message, the method comprising:
a message interface adapted to receive a message and a selection of one or more files from a content provider;
a page specification engine adapted to receive a page specification from a first entity, the page specification indicating one or more assets to be displayed in a message interface and the placement of the one or more assets in the message interface wherein at least one of the assets to be displayed in the message interface is to be selected by the content provider; and
a message interface generation engine adapted to generate a message interface based on the page specification, wherein the message interface is further adapted to display the message and a set of links to the one or more files in the message interface.

18. The system of claim 17, wherein:
the page specification is received from a first entity;
the upload server is further adapted to receive a selection of the at least one asset from the content provider; and
the message interface generation engine is further adapted to generate the message interface including the selected at least one asset.

19. The system of claim 17, wherein:
at least one of the assets to be displayed in the message interface is to be selected by an advertiser;
the upload server is further adapted to receive a selection of the at least one asset from the advertiser; and
the message interface generation engine is further adapted to generate the message interface including the selected at least one asset.

20. The system of claim 17, further comprising:
an ad bidding server adapted to receive an agreement to provide funds in exchange for the display of an asset from an advertiser; and
wherein the upload server is further adapted to receive an asset to be displayed from the advertiser and the message server is further adapted to display the asset in the message interface.
